(19) United States
(12) Patent Application Publication
(10) Pub. No.: US 2008/0308072 A1
(43) Pub. Date: Dec. 18, 2008

(54) HYDROCARBON SEPARATION FROM AIR USING MEMBRANE SEPARATORS IN RECIRCULATION TUBE

(76) Inventors: Raja Banerjee, Rochester Hills, MI (US); James T. Dumas, Clinton Township, MI (US); Randy C. Foster, Strafford, MO (US); Donald L. Gepper, Commerce Township, MI (US)

Correspondence Address: Joseph V. Tassone, Esq.;DAYCO PRODUCTS, LLC, 1 Prestige Place, Miamisburg, OH, 45342, US

(21) Appl. No.: 11/762,332

(22) Filed: Jun. 13, 2007

(51) Int. Cl. F02M 33/00

(52) U.S. Cl. 123/518

(57) ABSTRACT

A tubular separation system for separating a mixture of hydrocarbons and air at a fuel tank in an automotive vehicle, comprises; a fuel tank containing hydrocarbon fuel and a mixture of hydrocarbon fuel vapor and air; a fuel filler pipe connected to the fuel tank for conveying hydrocarbon fuel from a source of hydrocarbon fuel into the fuel tank; a separation module comprising a membrane for separating the hydrocarbon vapor from air; a first tubular member between the fuel tank and the separation module for conveying the mixture of air and hydrocarbon fuel vapor from the fuel tank to the separation module; a second tubular member between the separation module and the fuel tank for conveying hydrocarbon fuel vapor, separated from the mixture of air and hydrocarbon fuel vapor, from the separation module to the fuel tank; and a third tubular member between the separation module and the fuel filler pipe for conveying air, separated from the mixture of air and hydrocarbon fuel vapor, from the separation module to the fuel filler pipe. A device that provides a pressure differential across said membrane is employed to facilitate the separation of air and hydrocarbon from the air/hydrocarbon mixture. The air containing any residual fuel vapor is directed to an emissions canister where the residual fuel vapor is adsorbed and eventually consumed by the internal combustion engine while the air is released to the atmosphere.

### BACKGROUND OF THE INVENTION

The present invention relates to a fuel system for an internal combustion engine and, Particularly, to the separation of hydrocarbons from air in the separation tube at the fuel tank; and, most particularly, to a membrane separation system for providing a cleaner stream of air back into the fuel filler pipe.

Evaporative emissions result from any one of several events which includes venting of fuel vapors from the fuel tank due to diurnal changes in ambient pressure and/or temperatures (known in the art as “diurnal” emissions), by refueling of the vehicle (known in the art as “refueling” emissions) or by vaporization of fuel by a hot engine and/or exhaust. Generally, the venting of fuel vapor from the fuel tank due to diurnal pressure and/or temperature (diurnal emission) and the escape of fuel vapor during refueling are responsible for a majority of the emissions.

Environmental regulations imposed on the automotive industry, by the environmental Protection Agency require that automotive vehicles such as gasoline powered passenger cars and trucks have on board hydrocarbon emissions controls to prevent or limit the amount of hydrocarbon pollutants expelled into the atmosphere. Such hydrocarbon pollutants are a major contributor to smog formations and contribute to the depletion of the ozone layer in our atmosphere. As a result of government mandates, automotive manufacturers are constantly being challenged to find better and more efficient ways to prevent or reduce the emissions of hydrocarbon fuel vapors and other pollutants into the atmosphere. One such way that emissions can be controlled is by canister systems that employ carbon, preferably activated carbon, to adsorb and hold the hydrocarbon vapors. Examples of evaporative emissions canisters are described in a number of U.S. patents and patent applications such as U.S. Pat. No. 4,203,401 to Kingsley et al.; U.S. Pat. No. 4,658,796 To Yoshida et al.; U.S. Pat. No. 4,683,862 to Fornuto et al.; U.S. Pat. No. 5,119,791 to Gifford, et al.; U.S. Pat. No. 5,408,977 to Cotton; U.S. Pat. No. 5,924,410 to Dumas et al.; U.S. Pat. No. 5,957,114 to Johnson et al; U.S. Pat. No. 6,136,075 to Bragg et al; U.S. Pat. No. 6,237,574 to Jamrog et al.; U.S. Pat. No. 6,540,815 to Hiltzik et al.; and RE 38,844 to Hiltzik et al, and U.S. Pat. Appln. Nos. Nos. 2005/0061301 to Meiller; 2005/0123458 to Meiller; and 2006/0065252 to Meiller.

The adsorbed hydrocarbon vapor is periodically desorbed from the carbon by drawing fresh air into the carbon bed to displace the hydrocarbon fuel vapor. The displaced fuel vapor is then passed to the engine where it is consumed. The renewed carbon can then adsorb additional hydrocarbon fuel vapor from the fuel system by withdrawing the air back out through the vent side of the canister. The amount of fuel vapor that can be contained in the canister is finite and dependent upon the amount of carbon in the canister and the capability of the carbon to adsorb the fuel vapor until it is finally desorbed and consumed by the engine during purge cycles. Some prior art canisters employ auxiliary canisters to increase the adsorbent material capacity. The use of additional canisters not only increase the complexity and cost of the evaporative emissions system, but also requires additional space considerations due to the limited space available in the region of the vehicle wherein a canister is installed.

Fuel emissions can be further controlled by recirculation of fuel vapors in the fuel tank. The recirculation of fuel vapor during refueling from a fuel nozzle is described in U.S. Pat. No. 6,945,290 to Benjey et al. During refueling operations, displaced air that is saturated with fuel vapor, moves toward the external entry (filler pipe) and on to the carbon canister. During refueling, the displaced air/fuel mixture from the tank is circulated back near the filler pipe where it is reintroduced to the fuel tank in the fuel stream.

In view of the ever increasing government regulations preventing the escape of hydrocarbons into the atmosphere and the increasing cost of hydrocarbon fuel, there is a constant need for improved fuel systems which not only provide reduced fuel vapor emissions to the atmosphere but also provides for a more efficient use of the fuel.

### SUMMARY OF THE INVENTION

It has been found that hydrocarbon fuels can be more efficiently consumed and the emission of hydrocarbon fuel pollutants into the atmosphere during fueling of an automotive vehicle, during diurnal changes in the fuel system, and in the operation of such vehicle, can be substantially reduced or eliminated, by employing a recirculation tube to act as a closed loop vent from the fuel tank to the filler pipe, and integrally incorporating a membrane separation device into the recirculation tube. According to the present invention, the use of the membrane separation device provides effective separation of hydrocarbons from the air/fuel mixture at the fuel tank resulting in an air/fuel vapor effluent having a significantly reduced concentration of fuel vapor therein. A particular advantage of the present invention is that hydrocarbon emissions can be substantially eliminated while effectively reducing the size requirements of the emissions canister necessary to achieve the desired emissions level. The use of a smaller canister not only reduces manufacturing costs, but also permits significant flexibility in determining the most efficient configuration and location of the device in the emissions system.

By installing the membrane in the recirculation tube, the membrane separates a substantial amount of the hydrocarbon fuel from air at the fuel tank and recirculates the hydrocarbon fuel to the fuel tank, thereby reducing the load on the canister system so that the overall evaporative emissions system can be optimized by allowing the use of smaller canisters which can be more efficiently configured and located in the emissions system.

The use of a separating membrane device as described herein allows the use of a larger diameter recirculation tube thereby allowing a larger volume of the air/fuel mixture to flow through the recirculation tube, thereby reducing the pressure inside the fuel tank leading to a lower flow rate through the carbon canister employed to adsorb the fuel vapors until they are purged and consumed in the internal combustion engine. The effective separation of hydrocarbons from air based on a membrane separator is achieved with an effective pressure drop across the membrane module. This can be achieved more effectively by having a gas compressor or a vacuum pump in the recirculation tube to create the desired pressure head. The improvement provided by the present invention is a much cleaner stream of air fed back into the filler pipe, a significantly more efficient reduction in the amount of fugitive emissions released to the atmosphere during fueling, and more smaller spatial requirements for the emissions canister which not only reduces material and labor costs, but allows greater flexibility with respect to the installation of such canisters.

The membrane useful in the present invention is characterized as a cellular fibular material having physical properties such as pore size, nominal flow path, membrane area and thickness favorable for the separation and trapping of fuel vapor molecules while allowing any air molecules present to flow freely therethrough. Membranes found to be effective in the present invention are available from Amersham Biosciences Membrane Separations Group, W. L. Gore & Associates.

In addition to the afore-mentioned physical properties necessary for the sufficient separation of fuel vapor molecules from fresh air molecules in the evaporative emissions system, there are other properties that affect mass transfer during gas separation through a membrane. Such additional properties include:
Mobility Selectivity—It retards the movement of one species while allowing the movement of the other species. This is done by controlling the size distribution of the network of available passages (pores) to favor one of the components relative to the rest.
Solubility Selectivity—Selectivity is also determined by the relative sorptivity of the mixture components. Normal boiling point of mixture components is a good indicator of solubility selectivity. The higher the boiling point of a species, the more condensable is the gas and therefore higher is sorptivity.
Transport Plasticization—Due to the presence of a penetrant, the size range of transient gaps tends to be less sharply controlled and therefore mobility selectivity begin to fall. Therefore, interaction between mixture components and membrane material is important.
Operating Temperature—Higher temperature increases molecular diffusivity and less size-discriminating gaps in the polymer matrix. Therefore, permeability increases and selectivity decreases.
   Reference: R. W Baker, E. L. Cussler, W. Eykamp, W. J. Koros, R. L. Riley and H. Strathmann, Membrane Separation Systems Recent Developments and Future Directions, Chap 3, vol. II, pp. 189-241, Noyes Data Corp, New Jersey, USA, 1991.

In accordance with the invention, a module containing the membrane is positioned in a recirculating tube, which provides a closed loop vent from the fuel tank to the fuel filler pipe. During refueling, the displaced air/fuel vapor mixture from the fuel tank is passed to the membrane module where the membrane effectively separates the fuel vapor from the air/fuel mixture. Typically, the membrane is effective to prevent substantially all of the fuel vapor from passing therethrough while allowing substantially all of the air molecules to pass therethrough. The membrane allows the fuel vapor to return to the fuel tank while the air, separated from the air/fuel mixture, is allowed to freely pass to the filler pipe and eventually to the canister where any residual fuel vapor remaining in the air is adsorbed until it is consumed by the internal combustion engine during a purge step. More typically, the membrane prevents greater than about 80% of the fuel vapor molecules from passing through the membrane while allowing greater than about 95% of the air molecules to pass therethrough. Most typically, the membrane prevents greater than about 95% of the fuel vapor molecules from passing through the membrane while allowing greater than about 99% of the air molecules to pass therethrough. As in conventional canisters, the air substantially free of any fuel vapor is expelled through the canister to the atmosphere.

In one aspect of the invention, a gas compressor is placed between the fuel tank and the membrane module. In this design, the compressor is attached at the inlet of the membrane module, where it creates sufficient pressure head to provide a more effective separation of hydrocarbons from air wherein the hydrocarbons are returned to the fuel tank, while the clean air molecules are allowed to pass through the membrane.

In another aspect of the invention, a vacuum pump is placed between the membrane module and the filler pipe. The vacuum pump creates a significant pressure differential across the membrane module to draw clean air, separated from the air/hydrocarbon mixture, across the membrane module and introduce it to the recirculation tube while the separated hydrocarbons prevented from passing across the membrane module, are returned to the fuel tank. While a typical configuration would be to employ either the gas compressor or the vacuum pump in carrying out the invention, it is within the scope of the present invention to utilize both devices.

Accordingly, it is a primary object of this invention to provide an improved evaporative emissions system, which incorporates a membrane module in the recirculation tube at the fuel tank to separate most of the hydrocarbon fuel vapor from an air/hydrocarbon fuel vapor mixture, and return the hydrocarbon fuel vapor back to the fuel tank while allowing the clean air having a significantly reduced amount of hydrocarbon fuel vapor to pass on to the canister where the residual hydrocarbon fuel vapor is separated from the air and adsorbed on a bed of adsorbent material until it is desorbed in a purge step and consumed by the engine.

It is another object of the invention to provide an evaporative emissions system that provides reduced fuel emissions to the atmosphere.

It is still another object of the invention to optimize the overall packaging of the evaporative emissions system by allowing the use of smaller canisters, which can be more efficiently configured and located in the emissions system.

It is yet another object of the invention to provide all of the above objects of the invention with reduced complexity and economic considerations.

These objects as well as other objects, features and advantages of the present invention will be apparent to those skilled in the art from the following detailed description, appended claims and accompanying drawings.

### BRIEF DESCRIPTION OF THE DRAWINGS

FIG. 1 is a schematic illustration of one aspect of the invention; and

FIG. 2 is a schematic illustration of another aspect of the invention.

### DETAILED DESCRIPTION OF THE INVENTION

In accordance with the present invention, an effective separation system is employed for separating hydrocarbon fuel vapor molecules from air in an air/hydrocarbon fuel vapor mixture.

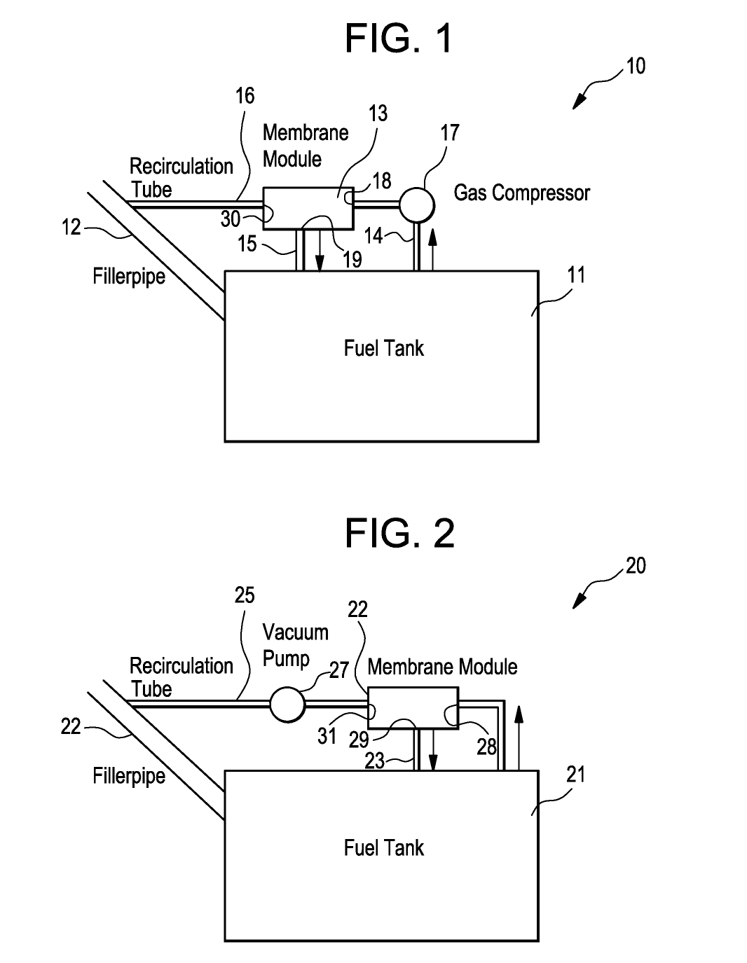

In one aspect of the invention, as illustrated in FIG. 1, the separation system 10 comprises a fuel tank 11 for receiving and storing fuel for powering an internal combustion engine. During the fueling stage where fuel from a fuel source, is pumped via a fuel nozzle into the fuel tank through filler pipe 12 via a fuel nozzle (not shown), pressure from a build-up of a vapor mixture of hydrocarbon fuel vapor and air causes the hydrocarbon fuel vapor/air mixture in the fuel tank 11 to flow from the fuel tank 11 to a membrane 32 disposed in a separation device 13 via port 18 through outlet line 14. The hydrocarbon fuel vapor is separated from the air/hydrocarbon fuel mixture in the membrane separation device 13 and returned to the fuel tank 11 via port 19 through hydrocarbon fuel return line 15. Air separated from the air/hydrocarbon fuel mixture in the membrane separation device 13 is passed on to the recirculation tube 16 via port 30 where it eventually passes to the filler pipe 12 to an adsorbent canister (not shown) where any residual hydrocarbon fuel vapor remaining in the air is adsorbed on a carbon bed and eventually consumed by the internal combustion engine, while the air, substantially free of any hydrocarbon fuel vapor, is discharged to the atmosphere. With respect to FIG. 1, the separation system further comprises a gas compressor 17 positioned between the fuel tank 11 and the membrane separation device 13 on the inlet side of the membrane separation device 13, where it creates sufficient pressure head on the membrane separation device 13 to assist the flow of the air/fuel vapor mixture through the membrane contained in the module 13 to provide an effective separation of hydrocarbon fuel vapor from air.

In another aspect of the invention, as best illustrated in FIG. 2, the separation system 20 comprises a fuel tank 21 for receiving and storing fuel for powering an internal combustion engine. During the fueling stage where fuel from a fuel source, is pumped via a fuel nozzle into the fuel tank through filler pipe 22 via a fuel nozzle (not shown), pressure from a build-up of a vapor mixture of hydrocarbon fuel vapor and air causes the hydrocarbon fuel vapor/air mixture in the fuel tank 21 to flow from the fuel tank 21 to a membrane 42 disposed in a separation device 23 via port 28 through an outlet line 24, The hydrocarbon fuel vapor is separated from the air/hydrocarbon fuel mixture in the membrane separation device 23 and returned to the fuel tank 21 via port 19 through hydrocarbon fuel return line 25. Air separated from the air/hydrocarbon fuel mixture in the membrane separation device 23 is passed on to the recirculation tube 25 via port 31 where it eventually passes to a canister (not shown) and any residual hydrocarbon fuel vapor remaining in the air is adsorbed on a carbon bed and eventually consumed by the engine, while the air, free of any hydrocarbon fuel vapor, is discharged to the atmosphere. With respect to FIG. 2, the separation system further comprises a vacuum pump 27 positioned between the fuel tank 21 and the membrane separation device 23 on the outlet side of the membrane separation device 23, where it creates sufficient pressure differential across the membrane separation device 33 to provide an effective separation of hydrocarbon fuel vapor from air.

While the present invention has been fully illustrated and described in detail, other designs, modifications and improvements will become apparent to those skilled in the art. Such designs, modifications and improvements are considered to be within the spirit of the present invention, the scope of which is determined only by the scope of the appended claims.

What is claimed is:

1. A tubular separation system for separating a mixture of fuel vapor and air at a fuel tank: in an automotive vehicle, said system comprising:
a fuel tank containing hydrocarbon fuel and a mixture of hydrocarbon fuel vapor and air;
a fuel filler pipe connected to said fuel tank for conveying hydrocarbon fuel from a source of hydrocarbon fuel into said fuel tank;
a separation module comprising a membrane for separating said hydrocarbon vapor from said air;
a first tubular member between said fuel tank and said separation module for conveying said mixture of air and said hydrocarbon fuel vapor from said fuel tank to said separation module;
a second tubular member between said separation module and said fuel tank for conveying hydrocarbon fuel vapor separated from said mixture of said air and said hydrocarbon fuel vapor, from said separation module to said fuel tank; and
a third tubular member between said separation module and said fuel filler pipe for conveying said air, separated from said mixture of said air and said hydrocarbon fuel vapor, from said separation module to said fuel filler pipe;

2. The system of claim 1 further comprising at least one device providing a pressure differential across said membrane.

3. The system of claim 2 wherein said at least one device providing a pressure differential across said membrane is a gas compressor.

4. The system of claim 3 wherein said gas compressor is disposed in said first tubular member at an inlet end of said separation module wherein said gas compressor creates a pressure head sufficient for effective separation of said mixture of said air and said hydrocarbon fuel vapor.

5. The system of claim 2 wherein said at least one device providing a pressure differential across said membrane is a vacuum pump.

6. The system of claim 5 wherein said vacuum pump is disposed in said third tubular member at an outlet end of said separation module wherein said vacuum pump creates a pressure differential sufficient to draw air separated from said mixture of air and said hydrocarbon fuel vapor, across said membrane and introduce said air to said third tubular member.

7. The system of claim 2 wherein said at least one device providing a pressure differential across said membrane comprises a gas compressor disposed in said first tubular member at an inlet end of said separation module, and a vacuum pump disposed in said third tubular member at an outlet end of said separation module.

8. The system of claim 1 wherein said membrane is characterized as a cellular fibular material having physical properties such as pore size, nominal flow path, membrane area and thickness favorable for the separation and trapping of fuel vapor molecules while allowing any air molecules present to flow freely therethrough.

9. The system of claim 8 wherein said membrane has an effective permeation with respect to hydrocarbon molecules of less than about 5%; and an effective permeation with respect to said air molecules greater than about 99%

10. The system of claim 1 wherein said membrane is disposed in a housing having a first port connected to said first tubular member for receiving said mixture of said air and said hydrocarbon fuel vapor, a second port connected to said second tubular member for conveying said hydrocarbon fuel vapor, separated from said mixture of said air and said hydrocarbon fuel vapor, from said separation module to said fuel tank, and a third port connected to said third tubular member for conveying said air, separated from said mixture of said air and said hydrocarbon fuel vapor, from said separation module to said fuel filler pipe.

11. A tubular separation system for separating a mixture of hydrocarbons and air at a fuel tank in an automotive vehicle, said system comprising:
a fuel tank containing hydrocarbon fuel and a mixture of hydrocarbon fuel vapor and air;
a separation module comprising a membrane for separating said hydrocarbon vapor from said air; wherein said membrane is disposed in a housing having a first port connected to said first tubular member for receiving said mixture of said air and said hydrocarbon fuel vapor, a second port connected to said second tubular member for conveying said hydrocarbon fuel vapor, separated from said mixture of said air and said hydrocarbon fuel vapor, from said separation module to said fuel tank, and a third port connected to said third tubular member for conveying said air, separated from said mixture of said air and said hydrocarbon fuel vapor, from said separation module to said fuel filler pipe.
a first tubular member between said fuel tank and said first port in said separation module, for conveying said mixture of air and said hydrocarbon fuel vapor from said fuel tank to said separation module;
a device disposed at an end of said separation module between said separation module and said first tubular member, said device providing a pressure differential across said membrane.
a second tubular member between said separation module and said fuel tank for conveying hydrocarbon fuel vapor, separated from said mixture of said air and said hydrocarbon fuel vapor, from said separation module to said fuel tank; and
a third tubular member between said separation module and said fuel filler pipe for conveying said air, separated from said mixture of said air and said hydrocarbon fuel vapor, from said separation module to said fuel filler pipe;

12. The system of claim 11 wherein said device is at an inlet to said separation module, said device being a gas compressor wherein said gas compressor creates a pressure head across said membrane sufficient for effective separation of said mixture of said air and said hydrocarbon fuel vapor.

13. The system of claim 12 wherein said device is at an outlet to said separation module, said device being a vacuum pump wherein said vacuum pump creates a vacuum across said membrane sufficient for effective separation of said mixture of said air and said hydrocarbon fuel vapor.

14. The system of claim 11 wherein said membrane is characterized as a cellular fibular material having physical properties such as pore size, nominal flow path, membrane area and thickness favorable for the separation and trapping of fuel vapor molecules while allowing any air molecules present to flow freely therethrough.

15. The system of claim 14 wherein said membrane has an effective permeation to hydrocarbon molecules of less than about 5% and an effective permeation with respect to said air molecules of greater than about 99%.

16. A method for reducing the emission of hydrocarbon fuel vapor into the atmosphere, said method comprising;
a fuel tank containing hydrocarbon fuel and a mixture of hydrocarbon fuel vapor and air;
a fuel tank containing hydrocarbon fuel and a mixture of hydrocarbon fuel vapor and air;
a separation module comprising a membrane for separating said hydrocarbon vapor from said air; wherein said membrane is disposed in a housing having a first port connected to said first tubular member for receiving said mixture of said air and said hydrocarbon fuel vapor, a second port connected to said second tubular member for conveying said hydrocarbon fuel vapor, separated from said mixture of said air and said hydrocarbon fuel vapor, from said separation module to said fuel tank, and a third port connected to said third tubular member for conveying said air, separated from said mixture of said air and said hydrocarbon fuel vapor, from said separation module to said fuel filler pipe.
a first tubular member between said fuel tank and said first port in said separation module, for conveying said mixture of air and said hydrocarbon fuel vapor from said fuel tank to said separation module;
a second tubular member between said separation module and said fuel tank for conveying hydrocarbon fuel vapor, separated from said mixture of said air and said hydrocarbon fuel vapor, from said separation module to said fuel tank; and
a third tubular member between said separation module and said fuel filler pipe for conveying said air, separated from said mixture of said air and said hydrocarbon fuel vapor, from said separation module to said fuel filler pipe; and
a device disposed at an end of said separation module between said separation module and said third tubular member, said device providing a pressure differential across said membrane.

17. The method of claim 16 wherein said device is a gas compressor disposed in said first tubular member at an inlet to said separation module wherein said gas compressor creates a pressure head across said membrane sufficient for effective separation of said mixture of said air and said hydrocarbon fuel vapor.

18. The method of claim 17 wherein said device is a vacuum pump disposed in said third tubular member at an outlet to said separation module wherein said vacuum pump creates a vacuum across said membrane sufficient for effective separation of said mixture of said air and said hydrocarbon fuel vapor.

19. The method of claim 16 wherein said membrane is characterized as a cellular fibular material having physical properties such as pore size, nominal flow path, membrane area and thickness favorable for the separation and trapping of fuel vapor molecules while allowing any air molecules present to flow freely therethrough.

20. The method of claim 19 wherein said membrane has an effective permeation with respect to hydrocarbon molecules of less than about 5% and an effective permeation with respect to said air molecules of greater than about 99%.
